(19) United States
(12) Patent Application Publication
(10) Pub. No.: US 2026/0280101 A1
(43) Pub. Date: Sep. 17, 2026

(54) RFID TAG HAVING AN ANTENNA WITH IMPROVED PROPERTIES

(71) Applicants: KORDSA TEKNIK TEKSTIL ANONIM SIRKETI, Kocaeli (TR); SES RFID SOLUTIONS GMBH, Duesseldorf (DE)

(72) Inventors: Mehmet Ilker YILMAZ, Kocaeli (TR); Hatice GOKDEMIR, Kocaeli (TR); Coskun KAZMA, Kocaeli (TR); Ezgi TAMAN ONEN, Kocaeli (TR); Martin SCATTERGOOD, Duesseldorf (DE); Yu Cheng LEE, Duesseldorf (DE)

(73) Assignees: KORDSA TEKNIK TEKSTIL ANONIM SIRKETI, Kocaeli (TR); SES RFID SOLUTIONS GMBH, Duesseldorf (DE)

(21) Appl. No.: 19/167,865

(22) PCT Filed: Feb. 6, 2024
(86) PCT No.: PCT/TR2024/050094

§ 371 Date: Sep. 23, 2025

(30) Foreign Application Priority Data
Mar. 24, 2023 (TR) 2023/003247

(51) Int. Cl. H01Q 1/22; G06K 19/077

(52) U.S. Cl. CPC H01Q 1/2241; G06K 19/07764; G06K 19/07773

(57) ABSTRACT

The provided is an electronic device configured to communicate radio frequency signals including; a chip a first antenna and a second antenna, where the second antenna is configured to form electromagnetic coupling with the first antenna and where the second antenna is configured to facilitate the communication of radio frequency signals including; a core including plurality of yarns, and a pair of protective yarns twisted around the core.

### CROSS-REFERENCE TO THE RELATED APPLICATIONS

This application is the national phase entry of International Application No. PCT/TR2024/050094, filed on Feb. 6, 2024, which is based upon and claims priority to Turkish Patent Application No. 2023/003247, filed on Mar. 24, 2023, the entire contents of which are incorporated herein by reference.

### TECHNICAL FIELD

The present invention relates to a device having means for detecting and emitting electromagnetic radiation and a corresponding antenna suitable to be mounted onto a tire. More specifically, electromagnetic radiation is in the range of radio frequency and that the device is an RFID tag with a yarn configured to conduct electrical signals and a tire comprising the same.

### BACKGROUND

It is known that incorporating electrical devices into tire structures has many advantages, such as tracking the tire during manufacture, transport and storing operations, as well as measuring and recording physical parameters, such as temperature and pressure. Different types of electrical devices are used in the art for these purposes, with radio frequency communication between the tire and an external monitoring or interrogating device being the most common. Such communication systems often include a radio-frequency identification (RFID) tag, and a reader that communicates with the RFID tag. The RFID tag includes an antenna and an RFID chip. Thus, information from the reader is received through the antenna and stored in an RFID chip, and the information stored in the RFID chip is transmitted to the reader through the antenna. RFID devices may be read-only, write-only, or read-and-write devices.

Use of RFID tags and corresponding antennas are common among a variety of applications including tires. Recently, attaching RFID tags into or onto a tire started to become a common application. Some of the problems, commonly faced in such applications can be summarized as low backscatter performance, difficulty in production, short reading distance. Another problem is the size of the antenna the tag has. In case, wherein the size of the antenna exceeds a predetermined length, it becomes harder to attach the antenna into the tire.

A prior art publication in the technical field of the present invention may be referred to as WO2017060222A1 among others, the document disclosing an antenna for use in an RFID tag. The antenna yarn comprises metal fibers. The metal fibers are stainless steel fibers. The antenna yarn is wrapped by at least one wrapping yarn thereby covering the full surface of the antenna yarn or of the metal wire or of the bundle of metal wires. The at least one wrapping yarn comprises non-electrically conductive fibers.

A prior art publication in the technical field of the present invention may be referred to as EP4063544A1 among others, the document disclosing a composite yarn supporting an electronic component and a method for producing the same.

### SUMMARY

It is an aim of the present invention to manufacture an RFID tag having an antenna wherein the manufacturing process of the RFID tag and that of the antenna is facilitated.

Another aim of the present invention is to improve signal strength of the antenna, thus increasing reading distance of the same.

Another aim of the present invention is to optimize the length of the antenna in accordance with the requirement of different types of tires.

A further aim of the present invention is to maximize backscatter therefore improving signal quality of the antenna.

Another aim of the present invention is to provide a unit comprising an RFID tag and an antenna with higher endurance.

The method realized to achieve the aim of the present invention and disclosed in the first claim and the dependent claims comprises an electronic device wherein the electronic device is able to communicate via radio frequency signal. In the preferred embodiment of the invention, said electronic device is an RFID tag. Said device comprises an antenna to strengthen signals and facilitate communication wherein the said antenna comprises a core mainly composed of a plurality of yarns twisted around each other. The core is then covered by means of a pair of protective yarns twisted around the core, completely enclosing the core. The core comprises a first yarn wherein the first yarn is made of aramid and a second yarn wherein the second yarn is made of of a metallic substance. In the preferred embodiment, metallic substance is steel but the person skilled in the art can apply any other metallic material that can be used for such an application. By means of combination of aramid and metallic but more preferably steel wires, higher signal strength is achieved. Additionally, reading distance is longer compared to conventional systems.

In the preferred embodiment of the invention, dtex value of the first yarn is between 400 and 700. In the most preferred embodiment of the invention said dtex value of said first yarn is 670. On the other hand, the second yarn comprises between 250 to 300 filaments but more preferably 270 to 280 filaments but even more preferably 275 filaments. Said range of filaments but more specifically 275 filaments provide improved signal strength.

In the preferred embodiment of the invention, second yarn has 50 to 200 TPM but more specifically 100 TPM. TPM is the twist per meter value commonly used for yarns.

In the preferred embodiment of the invention, the first yarn and the second yarn are twisted around each other by 200 to 300 TPM but more preferably 235 TPM. Said TPM range and value provides optimum signal strength meanwhile preventing breakage of metal filaments.

In the preferred embodiment of the invention, protective yarns are twisted around themselves by 75 to 250 but more preferably 90 to 200 but even more preferably 100 TPM. Additionally, dtex value of said protective yarns are between 450 to 500. Said dtex value ensures that the protective yarns are thick enough to protect core from outside. Additionally, protective yarns are twisted around the core between 1000 to 1400 TPM. One of the said protective yarn is Z twisted and the other one S twisted. In another embodiment, said protective yarns can have the same twist direction.

In the preferred embodiment of the invention, the antenna is primarily coated with a RFL solution and secondarily with a tackifying solution.

In the preferred embodiment of the invention, the electronic device is suitable to be used in a tire.

By means of the present invention, ease of production, high backscatter performance and longer reading distance is achieved. Additionally, signal strength is improved, and a stronger embodiment of antenna and RFID tag is realized.

### BRIEF DESCRIPTION OF THE DRAWINGS

The drawings are not meant to delimit the scope of protection as identified in the claims nor should they be referred to alone in an effort to interpret the scope identified in the claims without recourse to the technical disclosure in the description of the present invention.

FIG. 1—is a perspective view of the electronic device

FIG. 2—is a perspective view of the core and the protective yarn

FIG. 3—is a perspective view of the antenna

FIG. 4—is a cross sectional area of antenna along the dashed A-A lines in FIG. 3

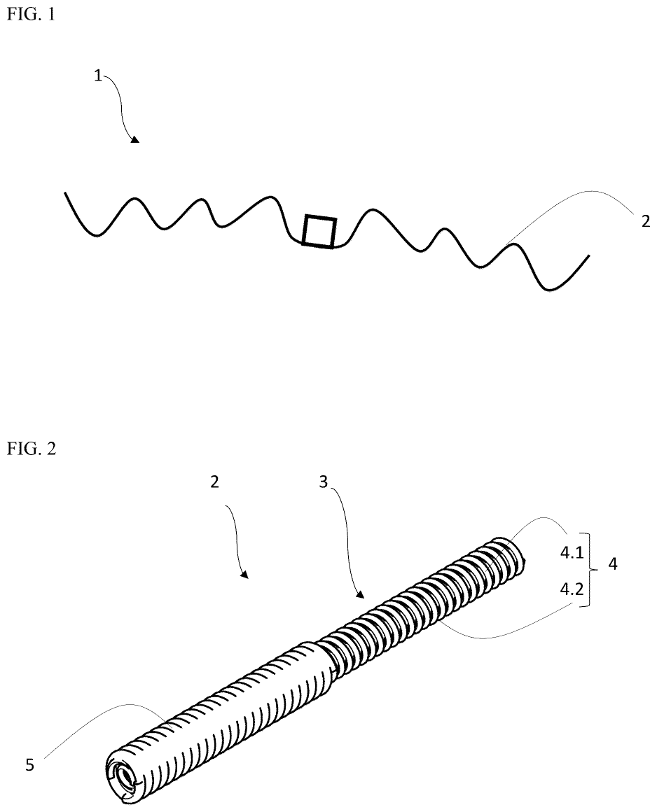

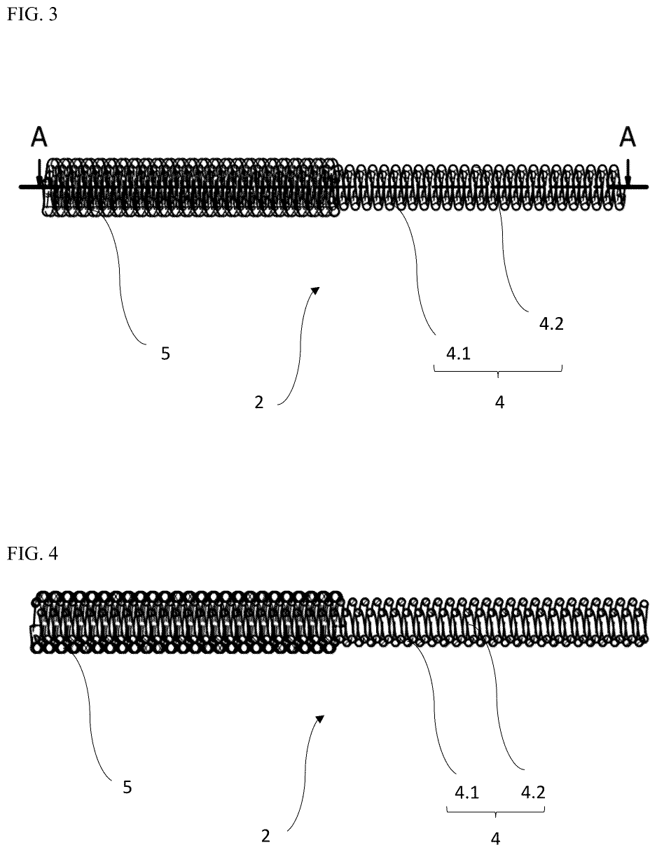

The following numerals are assigned to different parts demonstrated in the drawings and referred to in the present detailed description of the invention:
1. Electronic Device
2. Antenna
3. Core
4. Yarn
   4.1 First Yarn
   4.2 Second Yarn
5. Protective Yarn

### DETAILED DESCRIPTION OF THE EMBODIMENTS

The present invention relates to an electronic device (1) configured to communicate radio frequency signals comprising; a chip a first antenna and a second antenna (2), wherein the second antenna (2) is configured to form electromagnetic coupling with the first antenna and wherein the second antenna (2) is configured to facilitate the communication of radio frequency signals comprising; a core (3) comprising plurality of yarns (4.1,4.2), a pair of protective yarns (5) twisted around the core (3).

The present invention further comprises the core (3) which comprises a first yarn (4.1) made of aramid and a second yarn (4.2) made of steel wherein said yarns (4.1,4.2) are twisted around each other. Said electronic device (1) can be an identification or tracking device and can be used to record manufacturing, distribution, sales activities, temperature measuring, pressure measuring, or other physical properties in a tire during operation of the tire. Additionally, said electronic device (1) can be used to measure parameters during storage of the tire. In the preferred embodiment of the invention, said electric device (1) is an RFID transponder wherein said RFID transponder comprises a chip and the antenna (2), the antenna (2) being configured to facilitate the communication with an RFID reader, the reader being provided as an external part. The antenna (2) comprises the core (3), the core (3) being in elongated form to facilitate the transmission of radio waves and therefore data packages, comprises a pair of yarns (4.1,4.2). The first yarn (4.1) is made of aramid whereas the second yarns (4.2) is made of a metal but more preferably is made of steel. It needs to be understood that the skilled person in the art can use any metal that is known to increase signal strength in such applications. For instance, the second yarns (4.2) can be from copper, aluminum, titanium or silver. The first yarn and the second yarn (4.1,4.2) are Z and S twists. In a further embodiment the first yarn and the second yarn are S and Z twist. By means of twisting of said yarns (4.1,4.2) a spring effect is achieved thus decreasing chance of breakage of the core (3). Additionally, said yarns (4.1,4.2) are twisted around each other. They can be twisted around each other by a Z or an S twist which helps interlocking of the said (4.1,4.2). By means of the first yarn (4.1) being aramid and the second yarn (4.1) being made of a metallic wire but more preferably steel wire, signal transmission strength is improved meanwhile achieving higher backscatter performance. Said combination also provides longer reading distance. Said yarns (4.1,4.2) are afterwards covered by means of the protective yarns (5) wherein the number of protective yarns (5) in the preferred embodiment is two. The protective yarns (5) as the name suggests, provides a protective layer around core (3), namely first and second yarns (4.1,4.2), isolating said yarns (4.1,4.2) from environmental conditions and chemicals that the antenna (2) will be dipped in later.

In the preferred embodiment of the invention, the dtex value of the first yarn (4.1) is between 400 and 700. Said range has been found to be most optimum because dtex values higher than 700 makes the radius of the core (3) and therefore that of the antenna (2) thicker and outside the acceptable limits.

In the preferred embodiment of the invention, the second yarn (4.2) comprises between 250 to 300 filaments but more preferably 270 to 280 filaments but more preferably 275 filaments. The second yarn (4.2) comprises plurality of filaments made of metal. In an embodiment the number of filaments is between 250 to 300 to provide good signal strength. In another embodiment the number of filaments is between 270 to 280. Said ranges are important because they provide good signal strength meanwhile keeping the thickness of the core (3) at a minimum which prevents the core (3) from being recognized as a big foreign body inside the tire thus achieving good adhesion of the antenna (2) and electronic device (1) onto or into the tire. It was found experimentally that the 275 filaments is the most optimum choice as it provides superior signal strength, longer reading distance and high backscatter performance meanwhile keeping the thickness of the antenna (2) at a minimum thus providing good adhesion of the electronic device (1) into the tire.

In the preferred embodiment of the invention, the second yarn (4.2) has 50 to 200 TPM but more preferably 100 TPM. TPM means turn per meter of a yarn. 50 to 200 TPM but more preferably 100 TPM provides superior RSSI values. Said range of TPMs provides a smaller RSSI value, thus achieving better signal strength. In other words, signal strength is improved by −50 DB ±1 DB wherein DB stands for Decibel.

In the preferred embodiment of the invention, the yarns (4.1,4.2) are twisted around each other by 200 to 300 TPM but more preferably 235 TPM. To provide excellent fatigue resistance and conductivity performance, TPM value of said yarns (4.1,4.2) with respect to each other is very important. Therefore, in a preferred embodiment, said TPM value lies between 200 to 300 TPM but more preferably 235 TPM. 235 TPM has been found to be the most optimum value for providing good fatigue and conductivity performance. Another aspect one needs to consider is the fact that high TPM values such as 400 and higher increases possibility of breakage of metal, in this case steel, filaments.

In the preferred embodiment of the invention, the protective yarns (5) are 75 to 250 TPM but more preferably 90 to 200 TPM but even more preferably 100 TPM. The number of TPM of protective yarns (5) around the core (3) must be less than 200 as higher numbers causes the problem of formation of gaps in between the protective yarns (5). As a result of this, solution leaks to the core (3) of the antenna (2) which in turn will damage the core (3) or reduce signal strength. In the preferred embodiment of the present invention, one of the protective yarn (5) is Z twist whereas the other one is S twist. By means of using S and Z twists, core (3) is enclosed in a safe manner and completely.

The number of TPM of the pair protective yarns (5) with respect to themselves is 100 TPM.

In the preferred embodiment of the invention, the dtex value of protective yarns (5) is between 450 and 500. Dtex value of protective yarns (5) is important because high dtex values, namely higher than 500, makes the antenna (2) thicker than acceptable which in turn creates the effect of foreign matter behavior. As a result of this behavior, the electronic device (1) may detach from the tire. Additionally, higher dtex values increases the thickness of the electronic device (1) which in turn increases the weight of the electronic device (1). This enhances the problem of foreign matter behavior inside the tire. It was experimentally observed that the most optimum value of dtex for protective yarns (5) is 450.

In a preferred embodiment, protective yarns (5) are made of nylon.

In the preferred embodiment of the invention, the protective yarns (5) are twisted around the core (3) between 1000 to 2000 TPM. Mentioned TPM values are chosen so as to cover the second yarn (4.2) from outer environment which will increase service time of the electronic device (1). In a preferred embodiment, the protective yarns (5) are twisted around the core (3) between 1000 to 1400 TPM. It was experimentally observed that the most optimum value of TPM is between 1300 ±%6.

In the preferred embodiment of the invention, the antenna (2) is primarily coated with an RFL solution. In alternative embodiments, resorcinol formaldehyde-free (RF-free) compositions, such as compositions containing acrylic resins or natural latex, can be used. In alternative embodiments, a rosin ester and/or rosin ester tackifier may be added to the dipping solution. Solutions may be water-based or organic solved based. Organic solvents are chosen from a group containing toluene, hydrocarbon solvents, xylene, ethyl acetate, alcohols, ethers, and mixtures thereof. The antenna (2) is then coated by the tackifying solution and is then dried. However, the skilled person can appreciate that any method known in the art for improving the adhesion of components to rubber may be used in this application. The final aim is to ensure that the antenna (2) remains intact and adhered to or within the tire throughout the lifetime of the tire.

In the preferred embodiment of the invention, the electronic device (1) is used in a tire. The type of tire with which the electronic device (1) can be equipped include but are not limited to, bias tires, belted bias tires, radial tires, solid tires, semi-pneumatic tires, pneumatic tires, and airless tires. The electronic device (1) can be attached directly onto the rubber before curing process, embedding it between the layers comprising the final tire product. Apart from that, the electronic device can be mounted to any suitable location inside the tire.

An advantageous effect provided by means of the invention is that the simplified construction of the electronic device provides ease of production which in turn will help decrease manufacturing related costs.

Another advantageous effect provided by means of the invention is higher backscatter performance. Another advantageous effect provided by means of the invention is that the reading distance is longer than the antenna produced in accordance with previous methods.

Another advantageous effect provided by means of the invention is to provide an electronic device (1) having an antenna (2) having improved endurance and strength.

Another advantageous effect provided by means of the invention is that the signal strength of the electronic device (1) is improved.

What is claimed is:

1. An electronic device configured to communicate radio frequency signals comprising;
a chip, a first antenna and a second antenna, wherein the second antenna is configured to form electromagnetic coupling with the first antenna and wherein the second antenna is configured to facilitate communication of the radio frequency signals comprising; a core comprising a plurality of yarns,
a pair of protective yarns twisted around the core,
wherein
the core comprises a first yarn made of aramid and
a second yarn made of metal, wherein the first and second yarns are twisted around each other.

2. The electronic device according to claim 1, wherein a dtex value of the first yarn is between 400 and 700.

3. The electronic device according to claim 1, wherein the second yarn comprises between 250 to 300 filaments.

4. The electronic device according to claim 1, wherein the second yarn has 50 to 200 TPM.

5. The electronic device according to claim 1, wherein the first and second yarns are twisted around each other by 200 to 300 TPM.

6. The electronic device according to claim 1, wherein the protective yarns are 75 to 250 TPM.

7. The electronic device according to claim 1, wherein a dtex value of the protective yarns is between 450 and 500.

8. The electronic device according to claim 1, wherein the protective yarns are twisted around the core between 1000 to 1400 TPM.

9. The electronic device according to claim 1, wherein the second antenna is primarily coated with a RFL solution.

10. The electronic device according to claim 9, wherein the second antenna is secondarily coated with a tackifying solution.

11. The electronic device according to claim 10, wherein the tackifying solution contains at least one material selected from the group consisting of resorcinol formaldehyde latex solution, acrylic resin solution, rosin ester solution, natural latex solution, and combinations thereof.

12. A tire having the electronic device as described in claim 1.

13. The electronic device according to claim 3, wherein the second yarn comprises 275 filaments.

14. The electronic device according to claim 4, wherein the second yarn has 100 TPM.

15. The electronic device according to claim 5, wherein the first and second yarns are twisted around each other by 235 TPM.

16. The electronic device according to claim 6, wherein the protective yarns are 90 to 200 TPM.

17. The electronic device according to claim 2, wherein the second yarn comprises between 250 to 300 filaments.

18. The electronic device according to claim 2, wherein the second yarn has 50 to 200 TPM.

19. The electronic device according to claim 3, wherein the second yarn has 50 to 200 TPM.

20. The electronic device according to claim 2, wherein the first and second yarns are twisted around each other by 200 to 300 TPM.
